(19) United States
(12) Patent Application Publication
(10) Pub. No.: US 2014/0173249 A1
(43) Pub. Date: Jun. 19, 2014

(54) SYSTEM AND METHOD FOR CONNECTING A SYSTEM ON CHIP PROCESSOR AND AN EXTERNAL PROCESSOR

(71) Applicant: NVIDIA CORPORATION, Santa Clara, CA (US)

(72) Inventors: Thomas F. Fox, Palo Alto, CA (US); Gerrit A. Slavenburg, Fremont, CA (US)

(73) Assignee: NVIDIA CORPORATION, Santa Clara, CA (US)

(21) Appl. No.: 13/719,116

(22) Filed: Dec. 18, 2012

(51) Int. Cl. G06F 15/76

(52) U.S. Cl. CPC G06F 15/76
USPC 712/30

(57) ABSTRACT

A system and method are provided for connecting a system on chip (SoC) processor and an external processor. The SoC processor receives as input a content stream, and processes the content stream. Further, the application processor that is connected to the SoC processor receives the processed content stream, performs further processing on the processed content stream, and outputs the further processed content stream hack to the SoC processor.

### FIELD OF THE INVENTION

The present invention relates to content processing in electronic devices, and more particularly to system on chip processors.

### BACKGROUND

Traditionally, electronic devices have performed content processing solely using System on Chip (SoC) processors. For example, the system 100 as shown in Prior Art FIG. 1, a television SoC processor 102 in communication with dynamic random-access memory (DRAM) 104 has a plurality of inputs and an output to a television screen. The television SoC processor 102 receives via the inputs one or more content streams, processes the content streams, and outputs the processed content streams directly to the television screen. Thus, in the present example, the TV SoC processor 102 integrates almost all functions of the complete TV set.

Unfortunately, relying solely upon a SoC processor for content processing limits the extent to which content is capable of being processed. For example, the SoC processors typically are not capable of generating a graphical user interface (GUI) with the richness of that in a tablet, computer or high-end cell phone. The SoC processors also typically lack the central processing unit (CPU) and graphics power for sophisticated graphics content and games. There is thus a need for addressing these and/or other issues associated with the prior art.

### SUMMARY

A system and method are provided for connecting a system on chip (SoC) processor and an external processor. The SoC processor receives as input a content stream, and processes the content stream. Further, the application processor that is connected to the SoC processor receives the processed content stream, performs further processing on the processed content stream, and outputs the further processed content stream back to the SoC processor.

### BRIEF DESCRIPTION OF THE DRAWINGS

Prior Art FIG. 1 shows a system including a television system on chip (SoC) processor in communication with dynamic random-access memory (DRAM), in accordance with the prior art.

FIG. 2 shows a system including a SoC processor connected with an application processor, in accordance with yet another embodiment.

FIG. 3 shows a television system including a SoC processor connected with an application processor via a High-Definition Multimedia Interface (HDMI), in accordance with another embodiment.

FIG. 4 shows a television system including a SoC processor connected with an application processor via a Digital Serial Interface (DSI), in accordance with another embodiment.

FIG. 5 shows an application processor, in accordance with yet another embodiment.

FIGS. 6A-B show output of television system including a SoC processor connected with an application processor, in accordance with still yet other embodiments.

FIG. 7 shows an exemplary system in which the various architecture and/or functionality of the various previous embodiments may be implemented.

### DETAILED DESCRIPTION

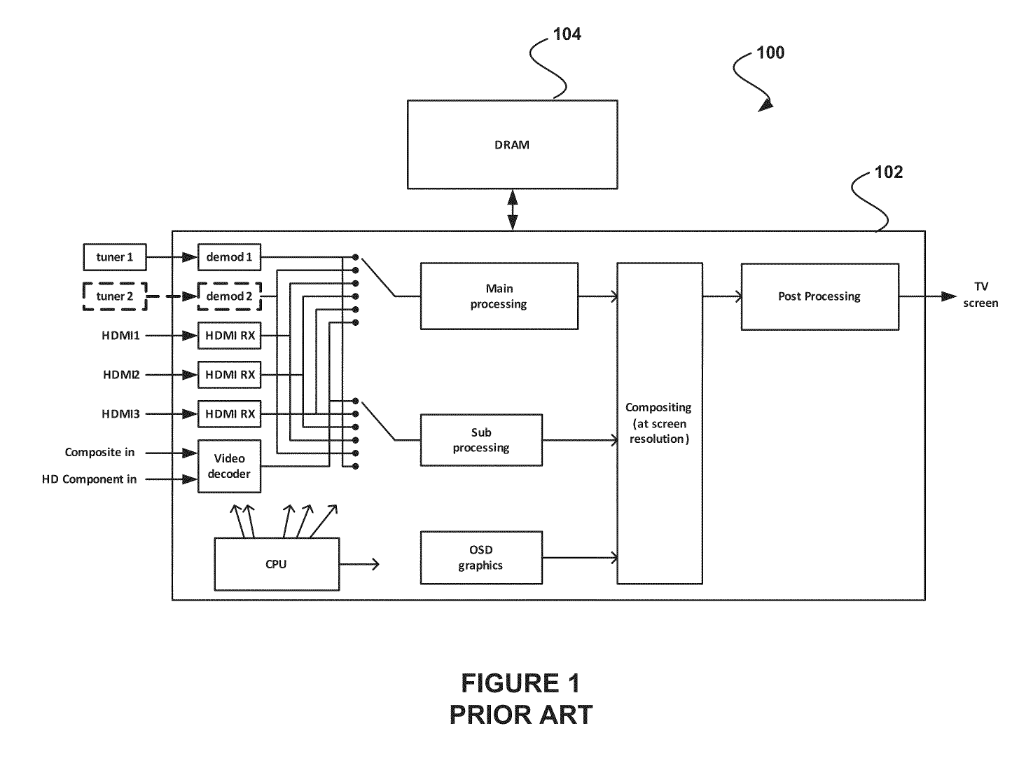

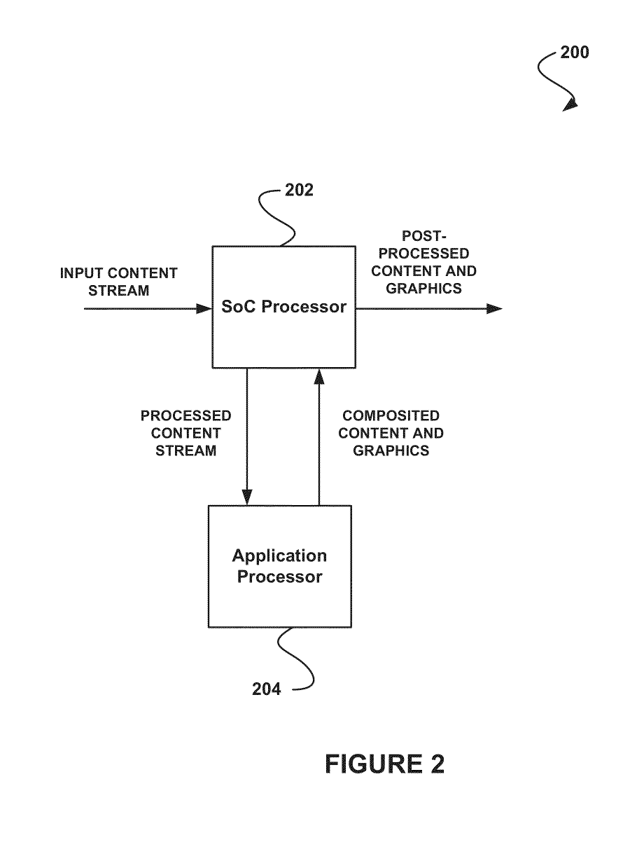

FIG. 2 shows a system 200 including a system on chip (SoC) processor 202 connected with an application processor 204. Such connection between the SoC processor 202 and the application processor 204 may be, at least in part, by way of a bus, such as a Peripheral Component Interconnect Express (PCIE), a Universal Asynchronous Receiver/Transmitter (UART), or any other interface allowing communications between the SoC processor 202 and the application processor 204. As shown, such communication between SoC processor 202 and the external processor 204 is bi-directional, as described in more detail below. Alternately, the bi-directional communication may be achieved by one or more uni-directional high-speed streaming interfaces, such as camera serial interface (CSI), digital serial interface (DSI), high-definition multimedia interface (HDMI), display port (DP), eDP, etc.

In the context of the present description, the SoC processor 202 may be any single package (e.g. integrated circuit, microchip, etc.) having electronic circuits and/or other components needed for a system (e.g. cell phone, set-top box, optical disc player, television, etc.) to operate. Thus, the SoC processor 202 may be a component of a consumer electronic device (e.g. television, set-top box, optical disc-player, cell phone, etc.) that enables operations of the consumer electronic device. Moreover, the SoC processor 202 may be highly integrated (e.g. platform dependent) with respect to the consumer electronic device, such that the SoC processor 202 is developed for the particular consumer electronic device in which it is integrated.

Also in the context of the present description, the application processor 204 may be any processor separate from the SoC processor 202 that is capable of being used in conjunction with the SoC processor 202 for processing content. In one embodiment, the application processor 204 may be designed to support applications, for example by processing graphics, etc. associated with those applications. Optionally, the application processor 204 may be platform independent.

The SoC processor 202 receives as input a content stream (e.g. for a content source). Thus, the SoC processor 202 includes at least one input connection for use by the SoC processor 202 in receiving as input the content stream. In one embodiment, the content stream may be received via the input connection from at least one external content source, such as a broadcast (e.g. cable) source, a set top box, BluRay player, etc. Accordingly, the input connection of the SoC processor 202 may be a tuner, HDMI, or any other interface capable of receiving the content stream (e.g. video, etc.). Of course, it should be noted that the SoC processor 202 is not necessarily limited to a single input connection, but may include a plurality of input connections each for use by the SoC processor 202 in receiving as input different types of content streams.

Additionally, the SoC processor 202 processes the received content stream. Accordingly, the SoC processor 202 includes at least one a processing component for processing the received content stream. Such processing component may be any processing block capable of performing operations on the received content stream. As an option, the processing performed by the processing component may include transforming at least one aspect of the received content stream. For example, such processing the received content stream may include performing on the content stream noise reduction, color correction, de-interlacing, scaling, etc.

As further shown, the application processor 204 is connected to the SoC processor 202, as described above, for receiving the processed content stream. Thus, the SoC processor 202 includes at least one output connection for outputting to the application processor 204 the processed content stream. The output connection may be a serial interface, such as a low pin-count CSI, or any other interface allowing the SoC processor 202 to output the processed content stream to the application processor 204. As shown in the present embodiment, the connection between the SoC processor 202 and the application processor 204 may be a direct connection (e.g. over a bus).

It should be noted that the SoC processor 202 may include a plurality of output connections, as an option. Just by way of example, where the SoC processor 202 receives as input multiple different types of content streams (e.g. via multiple different input connections of the SoC processor 202), the SoC processor 202 may be capable of outputting each content stream, once processed, to the application processor 204 via a different one of the output connections. Further, while the output connection is described in the present embodiment as being used for outputting a processed content stream to the application processor 204, it should also be noted that the SoC processor 202 may also include at least one other output connection (e.g. of a different type, etc.) for different outputting purposes, as described in more detail with reference to the subsequent figures.

In the present embodiment, the application processor 204 receives the processed content stream from the SoC processor 202. Such processed content stream may be received by the application processor 204 via one or more input connections of the application processor 204. Optionally, the input connections of the application processor 204 may be a camera serial interface (CSI), or any other interface allowing the application processor 204 to receive as input the processed content stream from the SoC processor 202.

The application processor 204 then performs further processing on the received processed content stream. The further processing performed by the application processor 204 may include compositing the received processed content stream with graphics (e.g. user interface, menu, etc.) processed by the application processor 204, just by way of example. As another example, the further processing performed by the application processor 204 may include merging and/or any other processing of the content received from the SoC processor 202 via the received processed content stream with other content received and decoded by the application processor 204 from another source. Such other content may be received over a network (e.g. an internet protocol (IP) network, WiFi network, Ethernet, etc.) from a source located on the network. Accordingly, the application processor 204 may include functionality for processing, in association with the received processed content stream, graphics or any other application-related content.

Moreover, the application processor 204 outputs the further processed content stream back to the SoC processor 202. Accordingly, the application processor 204 includes at least one output connection for outputting to the SoC processor 202 the further processed content stream, and the SoC processor 202 includes at least one further input connection for receiving from the application processor 204 the further processed content stream. For example, the further input connection of the SoC processor 202 and the output connection of the application processor 204 may be specifically used for communicating such further processed content stream from the application processor 204 to the SoC processor 202. In various embodiments, the output connection of the application processor 204 and the further input connection of the SoC processor 202 may be HDMI connections, DSI connections, or any other type of interface connections supporting the connection between the application processor 204 and the SoC processor 202.

As an option, the SoC processor 202 may include a post-processing component for performing post-processing on the further processed content stream received from the application processor 204. In one embodiment, the post-processing may be specific to a display screen to be used for displaying output of the post-processing component of the SoC processor 202. Just by way of example, the post-processing may include frame rate conversion, gamut mapping, gamma adjustment, etc.

Further, the SoC processor 202 includes a further output connection for outputting the post-processed content. Such output connection may be separate from the other output connection of the SoC processor 202 used for communicating with the application processor 204. For example, the further output connection may be specifically used for outputting the post-processed content from the post-processing component of the SoC processor 202. Accordingly, the further output connection may be an interface capable of being used for outputting the post-processed content from the post-processing component. In one embodiment, the output connection may output the post-processed content of the post-processing component of the SoC processor 202 to a display screen (e.g. for display thereof).

By connecting the SoC processor 202 with the application processor 204 in such a way that bi-directional communications are established between the SoC processor 202 and the application processor 204, as described above, a device having the SoC processor 202 may also realize the functionality of the application processor 204. In particular, content streams processed by the SoC processor 202 of the device may also be further processed by the application processor 204, thus allowing any enhanced processing capabilities of the application processor 204 (e.g. graphics processing, etc.) to be utilized by the device with respect to the content stream.

More illustrative information will now be set forth regarding various optional architectures and features with which the foregoing framework(s) may or may not be implemented, per the desires of the user. It should be strongly noted that the following information is set forth for illustrative purposes and should not be construed as limiting in any manner. Any of the following features may be optionally incorporated with or without the exclusion of other features described,

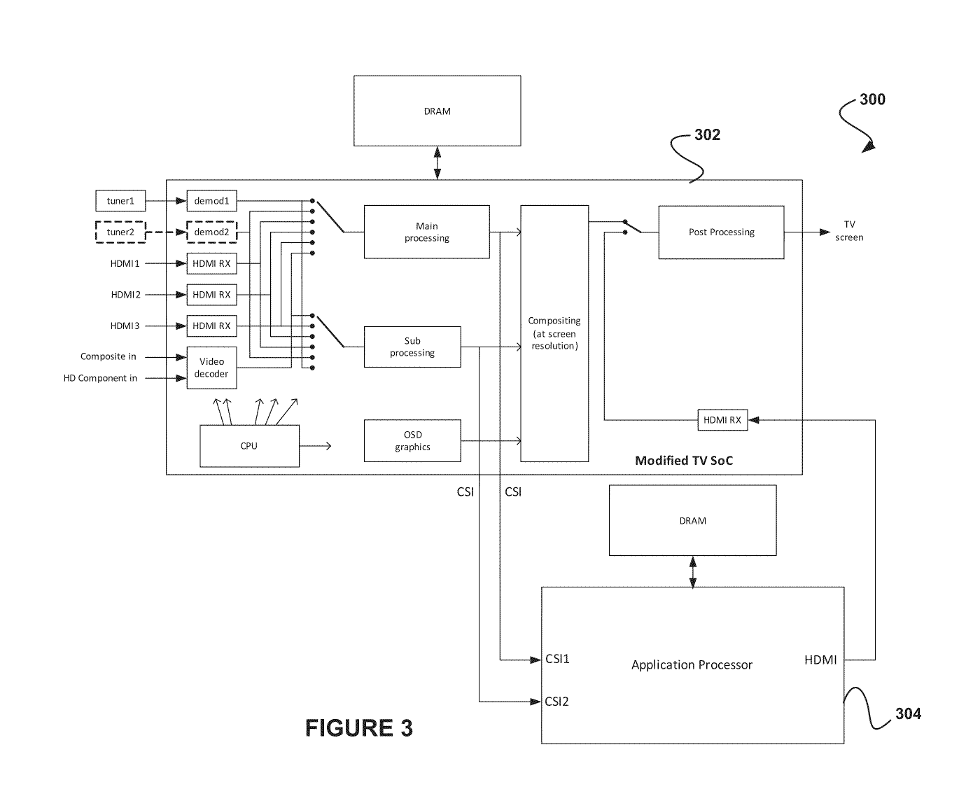

FIG. 3 shows a television system 300 including a SoC processor 302 connected with an application processor 304 via CSI and HDMI, in accordance with another embodiment. As an option, the television system 300 may be implemented in the context of FIG. 2. Of course, however, the television system 300 may be implemented in any desired environment. Again, it should be noted that the aforementioned definitions may apply during the present description.

As shown, the SoC processor 302 includes multiple input connections for use in receiving content streams from content sources. The inputs to the SoC processor 302 include one or two tuners for receiving broadcasts (or cable), several inputs for connecting external set top boxes (STB's), BluRay players, etc., and several analog inputs for Standard or High Definition analog devices. The image ultimately output to the television screen by the SoC processor 302 may consist of a combination of a main portion and a sub portion, for example picture-in-picture with the main portion at full-screen and the sub portion at a smaller size laid over the main portion, or side-by-side where both the main portion and the sub portion are half the horizontal (or vertical) screen size. Thus, under control of a central processing unit (CPU) on the SoC processor 302, one ‘Main’ content stream is selected from the inputs, for example tuned, and one ‘Sub’ content stream is selected from the inputs, for example HDMI3. Of course, it should be noted that while multiple content streams are described as being selected in the present embodiment, other embodiments may be limited to selection of only a single content stream (e.g. when picture-in-picture, etc. is not activated for the television).

The digital TV broadcast on tuner1 is decoded into a video stream by demod1 (also involving a digital video decoder, such as an mpeg-2 video decoder, not shown). The selected ‘Main’ content stream undergoes ‘Main Processing’ by a first processing component of the SoC processor 302, which serves the purpose to adapt the input video format to the final screen resolution, as well as do input adaptive processing (e.g. noise reduction, color correction, de-interlacing, scaling, etc.). The selected ‘Sub’ content stream undergoes ‘Sub processing’ by a second processing component of the SoC processor 302. The ‘Sub processing’ may be the same as the ‘Main Processing’, or may be similar to the ‘Main Processing’ except that it may be simplified and performed at a lower quality level (since ‘Sub’ is never shown at full-screen size).

To this end, the CPU on the SoC processor 302 controls all input connections of the SoC processor 302, all processing components of the SoC processor 302, and the main and Sub multiplexer of the SoC processor 302. In addition, using a simple graphics controller, the CPU of the SoC processor 302 may be capable of generating television On-Screen-Display (OSD) graphics, for example consisting of menus for navigation, user adjustment of contrast, brightness, etc.

In the embodiment shown, the SoC processor 302 is connected with the application processor 304. Such connection may be made by a manufacturer of the television system 300, as an option. For example, the application processor 304 may be embedded within a television box encompassing the television system 300, display, etc. As another option, the application processor 304 may be releasably connected to the SoC processor 302. For example, the television box may include a slot for receiving therein a plug-in card having the application processor 304, where such slot may be connected with the SoC processor 302. In this way, a consumer of the television may insert the application processor 304 into the slot for use of the application processor 304 in conjunction with the SoC processor 302 as desired.

When connected, the SoC processor 302 communicates with the application processor 304 such that the ‘Main’ content stream and the ‘Sub’ content stream are processed by both the SoC processor 302 (i.e. the processing components thereof) and the application processor 304. As shown, the processed ‘Main’ content stream output by the first processing component is communicated to the application processor 304 as is the processed ‘Sub’ content, stream output by the second processing component. In the embodiment shown, each of the ‘Main’ content stream and the ‘Sub’ content stream are communicated to the application processor 304 over separate communication lines, and are therefore received via separate interfaces (e.g. CSI's as shown) of the application processor 304.

The application processor 304 generates graphics using a graphics processor (e.g. graphics processing unit (GPU)), and also performs further processing on the received ‘Main’ content stream and the ‘Sub’ content stream. The graphics may include a user interface, menu, etc. In one embodiment, a compositing component of the application processor 304 may perform the further processing mentioned above by compositing the ‘Main’ content stream, the ‘Sub’ content stream, and any graphics generated by the application processor 304, to form a single image having the ‘Main’ content stream, the ‘Sub’ content stream, and graphics laid over one another in any predefined order such that all are visible at least in part. For example, the compositing may involve alpha blending, chroma keying, and other operations, where further the graphics may be laid on top of the live video (i.e. both of the composited ‘Main’ content stream and the ‘Sub’ content stream) with the live video ‘showing through’ the graphics (e.g. where the graphics is alpha blended on top of the video and thus semi-transparent in appearance).

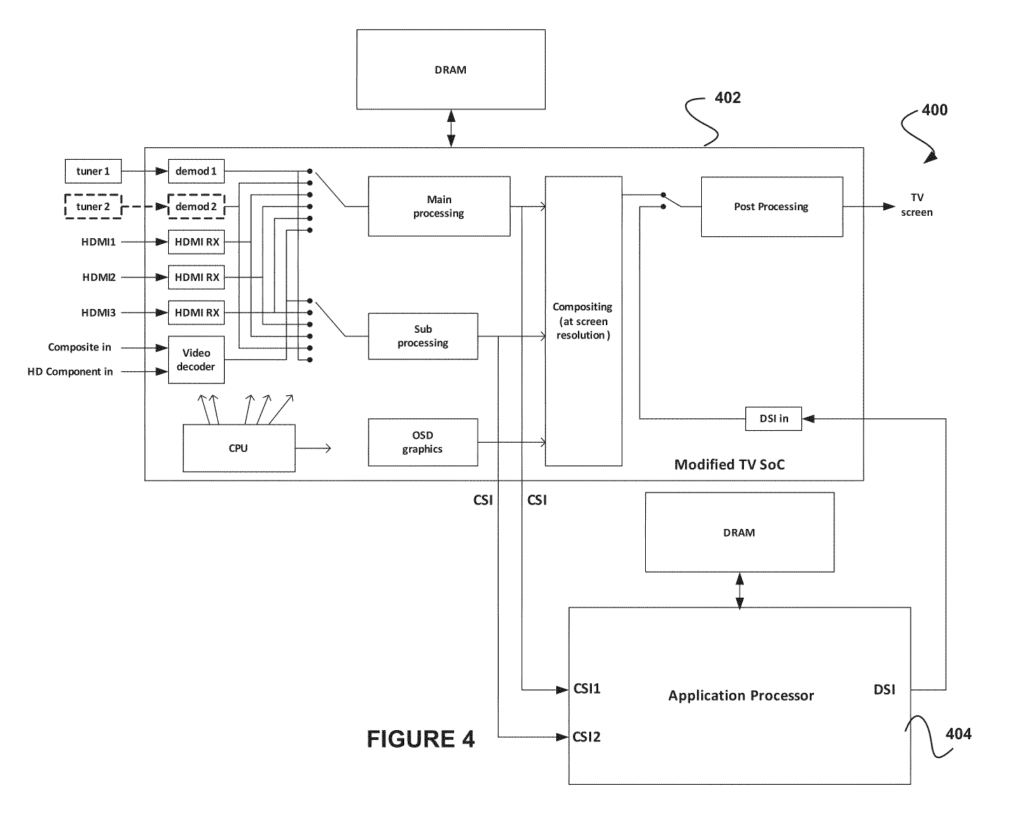

Upon completion of the further processing by the application processor 304, the application processor 304 outputs a result of such processing back to the SoC processor 302. As shown in FIG. 3, the application processor 304 includes an HDMI output connection to an HDMI input connection of the SoC processor 302, such that the final content generated by the application processor 304 (e.g. the composited image) is communicated over HDMI to the SoC processor 302. Of course, as another option shown in FIG. 4, the application processor 404 may include a DSI output connection to a DSI input connection of the SoC processor 402, such that the final content generated by the application processor 404 (e.g. the composited image) in the same manner described above with reference to FIG. 3 is communicated over DSI to the SoC processor 402.

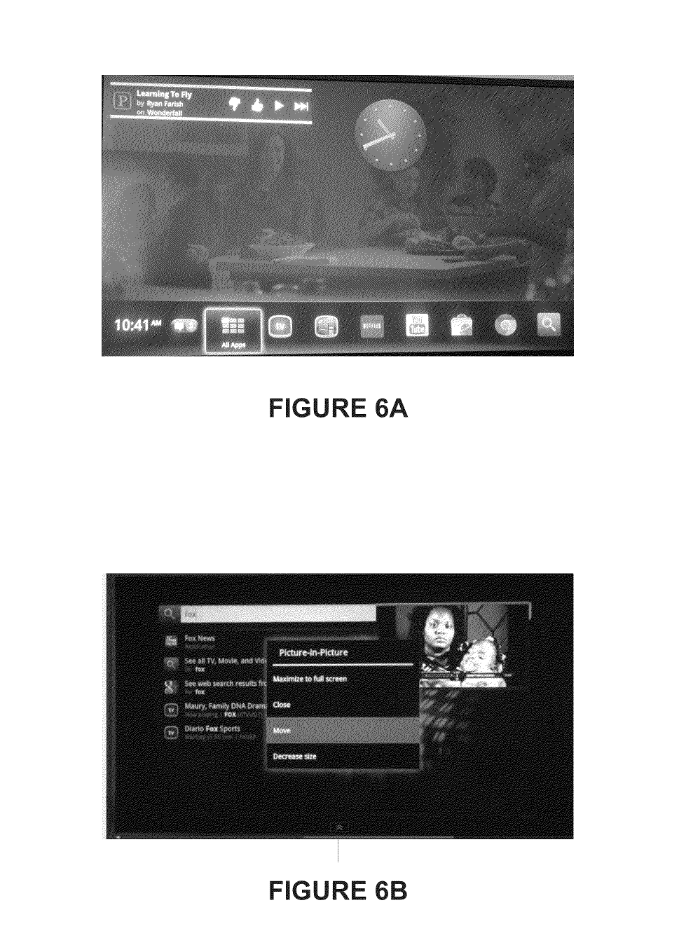

Upon receipt of the final content from the application processor 304 at the SoC processor 302, a post-processing component of the SoC processor 302 performs post-processing on the final content. Post-processing may involve frame rate conversion, which for example converts from the 60 Hz of the incoming video to 120 or 240 Hz of the television's liquid crystal display (LCD). Post-processing may also involve other processing including gamut mapping, gamma adjustment, etc. Post-processing may be specific to the television screen, whereas the ‘Main processing’ and ‘Sub processing’ described above may be dependent on a nature of the input selected. Examples of the result of such the processing by the SoC processor 302 and the application processor 304 are shown in FIGS. 6A-B as described below in more detail.

To this end, when the application processor 304 is connected with the SoC processor 302, the application processor 304 can perform the compositing of the ‘Main’ content stream and ‘Sub’ content stream processed by the SoC processor 302, such that the application processor 304 can composite such content streams with graphics generated by the application processor 304. This may allow the system 300 to provide (i.e. to the display screen) more advanced graphics with the content streams since the application processor 304 may be capable of generating more advanced graphics than the SoC processor 302. It should be noted that while the present embodiment has been described with respect to streaming television content, the integration of the application processor 304 with the SoC processor 302 can be used to stream Internet content decoded by the application processor 304, can be used for (e.g. cloud) gaming where the application processor 304 drives windows or full screen to the television screen, etc.

As an option, the aforementioned communications between the application processor 304 and the SoC processor 302 may be controlled by either the CPU of the SoC processor 302 or a CPU of the application processor 304. These CPUs may communicate by any desired interface (e.g. bus, PCIE, UART, etc.). Just by way of example, the CPU of the application processor 304 may instruct the CPU of the SoC processor 302 to direct output of the processing components of the SoC processor 302 over the CSI to the application processor 304.

In another embodiment (not shown), the SoC processor 302 may operate without the use of the application processor 304, such as when the application processor 304 is not connected with the SoC processor 302. For example, the SoC processor 302 may operate as is well known in the prior art when not connected with the application processor 304 (e.g. as shown in FIG. 1), such as by using its own compositing component to composite the ‘Main’ content stream, the ‘Sub’ content stream, and any graphics generated by an OSD graphics generator of the SoC processor 302, and by further outputting the final content from the compositing component to the post-processing component of the SoC processor 302 which further outputs the post-processed content to the display screen

Moreover, as described above, use of the CSI interface between the application processor 304 and the SoC processor 302 requires only minimal pins (at low cost) be added to the SoC processor 302 for the output connections thereof to the input connections of the application processor 304. Further, the CPU of the application processor 304 may be configured for controlling the communications between the application processor 304 and the SoC processor 302, such that the CPU of the SoC processor 302 may not necessarily require significant changes, programming, etc. to enable such communication. These techniques may allow the television manufacturer to use this modified SoC processor 302 without the application processor 304 (e.g. for lower-end television models) without significantly increasing a cost to manufacture the television, or to connect the modified SoC processor 302 with the application processor 304 (e.g. for higher-end television models).

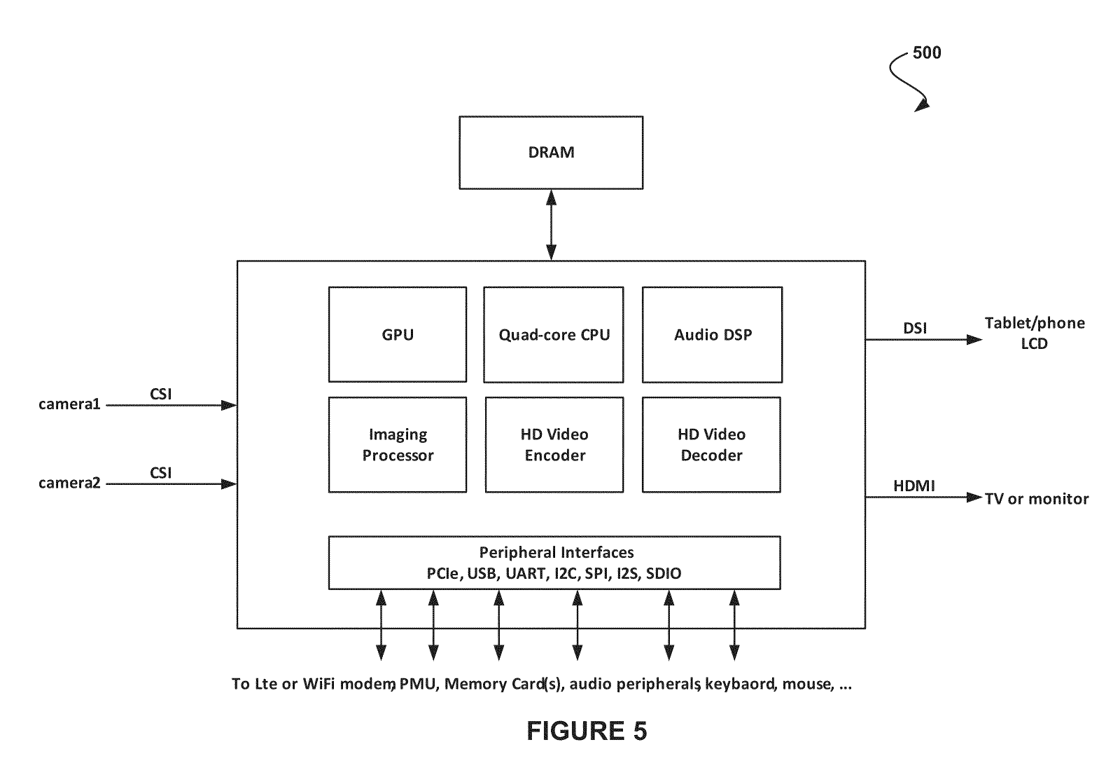

FIG. 5 shows an application processor 500, in accordance with yet another embodiment. As an option, the application processor 500 may be implemented in the context of the architecture of FIG. 24. Of course, however, the application processor 500 may be implemented in any desired environment. Yet again, it should be noted that the aforementioned definitions may apply during the present description.

As shown, the application processor 500 includes a GPU, quad-core CPU, HD Video encode and decode blocks, an audio processor and an imaging processor. The application processor 500 has two input connections which, as shown, use a low pin count Mobile Interface Processor Interface (MIPI) CSI. Upon receipt of content streams via the input connections, the application processor 500 is capable of using any of the various components described above to process the content streams. The application processor 500 has two output connections, which as shown include a DSI connection and HDMI connection. The output connections may be used to output the processed content streams.

FIGS. 6A-B show output of a television system including a SoC processor connected with an application processor, in accordance with still yet other embodiments. As shown in FIG. 6A, the television system displays content processed, at least in part, by both of the SoC processor and the application processor, where the displayed content includes that of a content stream as well as graphics. In the present embodiment, the content stream is a broadcast content stream (e.g. live video of a cable, etc, broadcast). Further, the graphics represent controls for a music application (i.e. Pandora music application, in the embodiment shown) and a presentation of a clock application, as well as a selectable menu of applications capable of being utilized by a user of the television system to access the applications using the television system.

As described above, the SoC processor performs initial processing of the content stream and communicates the processed content stream to the application processor. The application processor then generates the graphics and composites the processed content stream with the generated graphics. In the embodiment shown, the graphics are laid over the content stream with the live video ‘showing through’ the graphics (e.g. where the graphics is alpha blended on top of the video and thus semi-transparent in appearance).

As shown in FIG. 6B, the television system displays content processed, at least in part, by both of the SoC processor and the application processor, were the displayed content includes that of a content stream as well as graphics. In the present embodiment, the content stream is a broadcast content stream (e.g. live video of a cable, etc. broadcast). Further, the graphics represent a search function capable of being utilized by a user of the television system to search for content (e.g. Internet content, etc.), as well as a selectable menu of configuration options for the television system capable of being utilized by a user of the television system to configure a display format used by the television system (e.g. picture-in-picture, screen positioning of the content stream, sizing of the display of the content stream, etc.).

As described above, the SoC processor performs initial processing of the content stream and communicates the processed content stream to the application processor. The application processor then generates the graphics and composites the processed content stream with the generated graphics. In the embodiment shown, a portion of the graphics may be side-by-side with the content stream (e.g. as with the search function graphics), and another portion of the graphics may be in part laid over the content stream and/or other portion of the content stream (e.g. as with the television display configuration options).

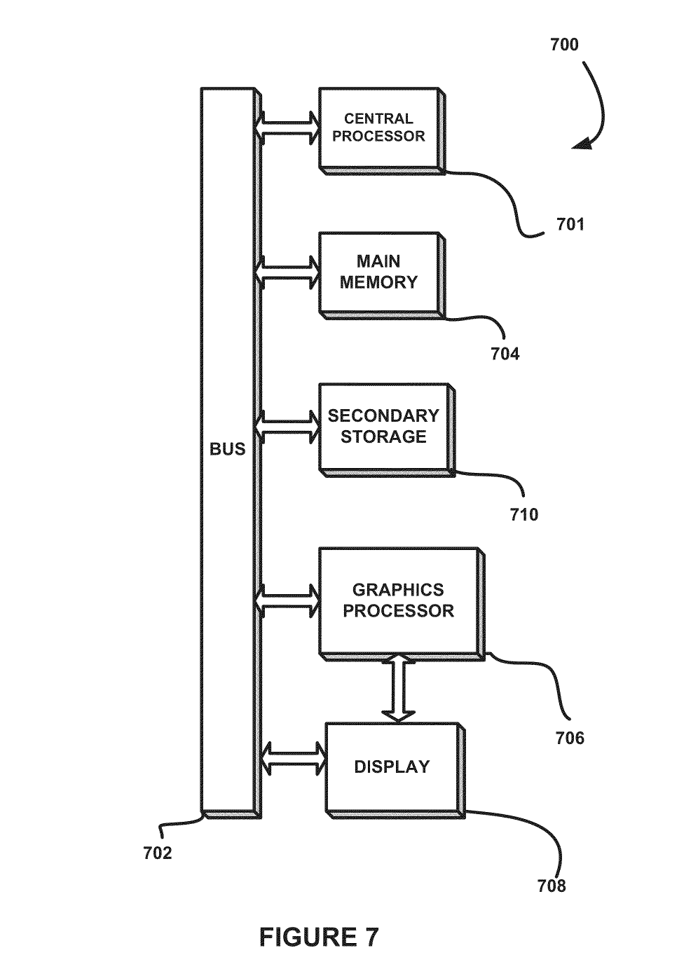

FIG. 7 illustrates an exemplary system 700 in which the various architecture and/or functionality of the various previous embodiments may be implemented. As shown, a system 700 is provided including at least one host processor 701 which is connected to a communication bus 702. The system 700 also includes a main memory 704. Control logic (software) and data are stored in the main memory 704 which may take the form of random access memory (RAM).

The system 700 also includes a graphics processor 706 and a display 708, i.e. a computer monitor. In one embodiment, the graphics processor 706 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 700 may also include a secondary storage 710. The secondary storage 710 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 704 and/or the secondary storage 710. Such computer programs, when executed, enable the system 700 to perform various functions. Memory 704, storage 710 and/or any other storage are possible examples of computer-readable media.

In one embodiment, the architecture and/or functionality of the various previous figures may be implemented in the context of the host processor 701, graphics processor 706, an integrated circuit (not shown) that is capable of at least a portion of the capabilities of both the host processor 701 and the graphics processor 706, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 700 may take the form of a desktop computer, lap-top computer, and/or any other type of logic. Still yet, the system 700 may take the form of various other devices m including, but not limited to a personal digital assistant (PDA) device, a mobile phone device, a television, etc.

Further, while not shown, the system 700 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A system, comprising:
a system on chip (SoC) processor for:
receiving as input a content stream, and
processing the content stream; and
an application processor connected to the SoC processor for:
receiving the processed content stream,
performing further processing on the processed content stream, and
outputting the further processed content stream back to the SoC processor.

2. The system of claim 1, wherein the SoC processor is a component of a consumer electronic device.

3. The system of claim 1, wherein the SoC processor is a component of a television.

4. The system of claim 1, wherein the content stream is received via the input connection from at least one external content source.

5. The system of claim 1, wherein the SoC processor includes a plurality of input connections each for use by the SoC processor in receiving as input different types of content streams.

6. The system of claim 1, wherein a processing component of the SoC processor processes the received content stream by transforming at least one aspect of the received content stream.

7. The system of claim 1, wherein a processing component of the SoC processor processes the received content stream by performing on the received content stream at least one of noise reduction, color correction, de-interlacing, and scaling.

8. The system of claim 1, wherein the application processor processes graphics.

9. The system of claim 8, wherein the further processing performed by the application processor includes compositing the processed content stream with the graphics.

10. The system of claim 8, wherein the graphics include a user interface.

11. The system of claim 1, wherein the SoC processor includes an input connection for use in receiving the further processed content stream from the application processor.

12. The system of claim 1, wherein the SoC processor includes a post-processing component for performing post-processing on the further processed content stream received from the application processor.

13. The system of claim 12, wherein the post-processing is specific to a display screen to be used for displaying output of the post-processing component of the SoC processor.

14. The system of claim 13, wherein the SoC processor includes output connection for outputting to the display screen the output of the post-processing component of the SoC processor.

15. The system of claim 1, wherein the SoC processor and the application processor connected via a bus.

16. The system of claim 1, wherein the SoC processor includes a first central processing unit, the application processor includes a second central processing unit, and further the first central processing unit of the SoC processor is under the control of the second central processing unit of the application processor.

17. A method, comprising:
receiving as input, by a system on chip (SoC) processor, a content stream;
processing the received content stream using the SoC processor;
outputting to an application processor connected to the SoC processor the processed content stream;
performing further processing on the processed content stream in response to receipt of the processed content stream, by the application processor; and
outputting the further processed content stream back to the SoC processor, using the application processor.
